(19) United States
(12) Patent Application Publication
(10) Pub. No.: US 2005/0007965 A1
(43) Pub. Date: Jan. 13, 2005

(54) Conferencing system

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/852,581

(22) Filed: May 24, 2004

Related U.S. Application Data
(60) Provisional application No. 60/473,038, filed on May 24, 2003.

(51) Int. Cl. H04M 3/42

(52) U.S. Cl. 370/260; 379/202.01

(57) ABSTRACT

A conferencing system that enables communication between at least two portals on a network. An audiovisual feature enables users at portals simultaneously see and hear each other from their respective portals. A remote control feature enables the portals to share, display, and/or control software applications or an entire desktop from a remote location. A media streamer feature enables a host portal in a conference to stream local media files to other portals. A text data transfer feature enables real time transfer of text and binary data between portals. A file transfer feature enables portals participating in a conference to physically transfer files between them. An input/out feature enables a portal participating in a conference to detect and send data to peripheral devices connected to the ports of another portals participating in the conference.

This application claims the benefit of U.S. Provisional Application No. 60/473,038, filed on May 24, 2003.

### BACKGROUND OF THE INVENTION

The present invention is directed towards a an internet protocol based conferencing system that provides a multitude of features such as encryption, security, call routing, administrative reporting, and reliable connectivity.

Gatelinx, Corp., assignee of the present invention, has proposed several systems, methods, and apparatuses for improving sales to potential consumers through a number of portals, such as stationary kiosks, set top boxes, portable kiosks, desktop computers, laptops, handheld computers, cell phones and personal digital assistants. These inventions are disclosed in application Ser. No. 09/614,399 for NETWORK KIOSK, Ser. No. 09/680,796 for SMALL FOOTPRINT NETWORK KIOSK, Ser. No. 09/750,954 for INTERACTIVE TELEVISION FOR PROMOTING GOODS AND SERVICES, Ser. No. 09/842,997 for METHOD TO ATTRACT CONSUMERS TO A SALES AGENT, and Ser. No. 09/873,034 for BACKEND COMMERCE ENGINE. The present invention is directed towards a robust, internet-based conferencing system that enables conferencing between two or more portals.

Since the mid-1990s, internet based conferencing systems have been used by companies striving to improve customer service on their websites and at kiosks. By employing this live support functionality, these companies have realized significant increases in sales and drops in support costs. These prior art conferencing systems, however, include many unique challenges that inhibit their effectiveness. The most critical challenges have been the inability to connect over the internet in spite of firewalls and connection error management. In particular, most prior art videoconferencing packages are based on H.323 (SIP and RTSP), which is a standard for transferring multimedia videoconferencing data over networks. Unfortunately, this standard does not take into account common difficulties faced when trying to establish and maintain connectivity over the internet. Firewalls, software incompatibilities, and low bandwidth all cause live video connections across the internet to have inconsistent connectivity, poor quality, and very slow data transfer rates.

Also, most prior art internet based conferencing systems do not include encryption functionality because streaming media has typically included large amounts of data. As the importance of secure communications over the internet has grown, the practice of allowing unencrypted communications is unacceptable to most companies.

Thus, there is a need in the art for a secure, robust, internet based conferencing system that provides reliable connectivity in spite of firewalls, connection error management, real-time data transfer, encryption, and a collection of high-quality features.

### BRIEF SUMMARY OF THE PRESENT INVENTION

A conferencing system including a plurality of remote portals on a network that are adapted to generate and receive conferencing requests, a queue server that handles conferencing requests from the plurality of remote portals, a director that locates a router on the network to process each conferencing request, and a plurality of features that may be accessed during a conference between at least two of the remote portals. The director establishes a peer-to-peer connection between at least two of the remote portals to create a conference.

The conferencing system enables the portals to launch a number of features including an audiovisual feature that permits users at portals participating in a conference to simultaneously see and hear each other from their respective portals. A remote control feature is provided that enables the portals participating in a conference to share, display, and/or control software applications or an entire desktop from a remote location. A media streamer feature enables a host portal in a conference to stream local media files to other portals participating in the conference. A text data transfer feature enables real time transfer of text and binary data between portals participating in a conference. A file transfer feature enables portals participating in a conference to physically transfer files between them. An input/out feature is also provided that enables a portal participating in a conference to detect and send data to peripheral devices connected to the ports of another portals participating in the conference. A legacy gateway feature enables portals on the network to send or receive conference calls that do not originate from other compatible portals on the network by converting the calls into a format compatible with the system. A messaging feature enables portals on the network to leave a text, video, and/or audio message for an unavailable portal. Call monitoring and call recording features are also available in the present system.

### DETAILED DESCRIPTION OF THE PREFERRED EMBODIMENTS

The examples discussed in the following description are provided for the purpose of describing the preferred embodiments of the invention and are not intended to limit the invention thereto.

The present invention is directed towards a conferencing system that enables conferencing between two or more portals over the internet. To this end, a network must be in place to allow communication over the internet between a plurality of portals. The communication system may include a managed portal network operated by a service provider operating according to the present invention, although this need not be the case. The managed portal network interfaces with the internet and particularly with the world wide web. A plurality of portals may be connected directly to the managed network, indirectly through an internet service provider, or through some other medium. The portals of the present invention may comprise computers that may reside in the form of stationary kiosks, portable kiosks, desktop computers, laptops, handheld computers, set-top boxes, and personal digital assistants, for example.

The present invention enables the various portals to place conferencing requests to and receive conferencing requests from one another. In order to receive incoming conferencing requests, however, a portal must be logged into the system. Thus, the process of establishing an internet conference between two or more portals commences when the portals log into a queue server, which is a server that acts as a handler for call placement requests. This login process enables the system to validate the user of the portal through the use of a login and password, for example. Also, the queue server enables an administrator to access data on authorized users such as when the user logs in and out, how many calls the user has taken, the lengths of those calls, total calls in progress, and other types of statistical data. The login process further enables the system to track call activity for billing purposes. Thus, the queue server may be configured to save this information to a billing database. A web based administration module is provided to manage the login process, billing, call routing patterns, etc., as discussed further below.

When portals login, logout, enter a conference, or intend to be marked as unavailable, they may send an update to the queue server indicating their current state. This presence information is then broadcast to all portals that have specifically requested presence information for that portal. More specifically, each portal registers its presence state with the queue server. The presence data indicates whether the portals are on a call, have a do-not-disturb flag on, or are available. In addition the presence system can flag other information about a portal, such as the presence of a camera and microphone.

In order for a portal on the network to read presence data about another portal, the user interface of the desiring portal subscribes to the other portal's presence state. In one embodiment, the queue server polls the presence database for the portals on the network and gets back a list of changed states to send to all portals that subscribe to presence data through that queue server. In an additional embodiment, when a portal changes its presence state, the presence subscriptions are sent as a global network request. that is routed to the queues servers of all portals that have subscribed to the particular portal's presence state. Each queue server sends the updated state down to the subscribed users.

Once the portals are logged into the queue server, they may request conferences with one another. To aid in describing how this process works, an example of a kiosk that requests to initiate a conference with a remote sales agent is used throughout this description. It should be understood, however, that the present invention is not limited to this particular application. Rather, any type of portal may request a conference with any other portal. It should also be understood that the present invention is not limited to portal-to-portal conferences. Rather, any one portal can request a conference with multiple other portals at the same time.

The conference request is generated from the kiosk via an application interface, which is referred to herein as a client. This may occur when a customer in a store approaches the kiosk and touches the screen or button to initiate a conference call with a remote sales agent. The area of the screen or button may read “Call Now” or “Press Here To Speak To A Live Agent.” At that point, a request is generated from the kiosk to initiate a conference call.

Once the request is generated by the kiosk, an executable program referred to herein as a director attempts to establish a connection between the kiosk and the remote portal. In particular, the director attempts to locate a switch that will forward the request to a router that can process the conference call request from the kiosk as a series of jobs. The director locates the back end by attempting to simultaneously connect to multiple switches on the network. Each switch is configured to sleep before responding to a request as its performance degrades. Correspondingly, each switch is configured to decrease it response time as its performance level improves. Each switch is preferably configured to reject connections if its performance level reaches critical levels. The closest switch to the requesting director is contacted based on its connection time but the best performing switch is selected by adding the performance delay to the connection time. Therefore, the director connects to the closest, best performing switch, which is the first switch to respond to the request. The selected switch then selects the closest, best performing router using the same methodology used to select the switch.

The selected router may examine information from the kiosk, select the company to contact based on the owner/lessee of the kiosk, and select the one or more sales agents that are to receive the conference call based on the company's routing pattern and/or information that is input into the kiosk by the user. These call routing patterns may be developed so they are supported by standard telephone PBX switches or similar systems, however, the routing patterns are not limited to this type of configuration. Some of examples of call routing methods include intelligent (criteria-based) priority, longest-waiting, multi-ring, random and distributed routing.

As referenced above, the login process, billing, and call routing methods are managed by a web based administration module of the present system. Similarly, call statistics, permission levels, and scripts are managed by the administration module on the back-end.

Referring again to the scenario, once the router has selected one or more recipients who may meet the needs of the requesting kiosk, the director contacts the recipient and notifies it of the request. If the recipient is not logged on to the queue server, the call request fails and the router changes the “request” into a “response” that is sent back to the director indicating a failed connection. Even if the recipient portal is logged on to the queue server, the recipient portal may either accept or decline the call. If the recipient portal declines the request, the system may be configured so that the next recipient in the routing pattern is contacted. If the recipient accepts the request, the router responds to the director with connection information. The director then uses the connection information for both the requesting and recipient portals to launch a peer-to-peer connection through a managed data transport system.

In the case of multi-party conferencing, several peer-to-peer calls are merged into a single call at a server site. Specifically, a multi-party server takes data from the features on each portal, merges that data, then sends the result out to the appropriate portals. It does this by having a special version of the director program. This special version has extra signaling to handle multiple users joining and leaving a conference at any time. In theory, the number of users that may be within a conference at once is only limited by the hardware on the server. Also, the number of simultaneous conferences is only limited by the server hardware.

Control of a multi-party conference occurs through a special feature, the multi-user conference feature (MUC). The MUC acts as a conduit to the server MUC (SMUC), and performs two jobs. The first is the management of the multi-party call itself by allowing the conference leader to have the server call other users into the conference and notify the user interface when those users join and depart the conference. The second role of the MUC is to act as a conduit for messages to reach the other server features. Two XML files define what the MUC does when it receives a particular message. One file is on all of the portals, the other file is on the server. Messages sent to the MUC can be routed to the SMUC, or used to invoke a portal feature, which features are discussed in detail below. If the message is sent to the SMUC, it may be used to invoke a server feature, or be routed to one or more portal MUCs. If the message is routed to one or more MUCs, the MUCs notify their user interfaces of the new message, and the user interfaces can retrieve the messages from a message queue in each MUC. In other words, the MUC reads a specialized configuration file that defines each potential incoming and outgoing message and lists a set of actions for each. Messages can be forwarded, used to invoke a feature on either the client or server, and new messages may be created and sent to either the client or server.

Various features that are responsible for transmitting and receiving certain types of data may be implemented during a conference between two or more portals using the managed data transport system referred to above. These features may be used to inform the customer at a kiosk of product information, show movies regarding the product, display an image of a sales representative, and enable the customer and sales agent to discuss the product, for example. To enhance the stability of the conference and the overall invention, each feature is encased in its own process, and communicates with the director and the application launching the conference via inter-process communication. As long as the director and the program that initialized the conference are running, the conference will be active even if individual features encounter irrecoverable errors. For example, multimedia programs can be much more unstable than less graphically intense applications due to driver conflicts and other issues. Using this strategy, if a multimedia feature were to terminate unexpectedly, the other less intense features would continue to transmit and receive conference data.

When one of the portals in a conference launches a feature either through its client interface or by launching an application or webpage in an embedded feature, the portal notifies the director of its existence. The director sends a signal to the remote portal's director, and the remote director may either accept or reject the feature based on the remote portal's preferences and scripts, as described below.

If the remote director accepts the feature, the feature start is synchronized between the two portals. Particularly, the director tells the features where to create the multiple channels in the managed transport system. The features are implemented over those channels and displayed at the portals via the client. A scripting engine may be utilized to allow for flexible, customized control of these features within the client and any portal participating in the conference may initiate one or more of the features. However, when one portal attempts to initiate a feature, the other participating portal(s) should agree to use the feature before it can be executed.

In addition to controlling the start and termination of conferences and launching features used during the conference, the director manages user preferences. Preferences are pieces of information about the portal's working environment. Some of these preferences apply to the portal as a whole, such as the available hardware. Others are specific to a user when logged into a specific portal. Other preferences are unique to the user and will be available to the user on any portal they use to log into the system. These floating preferences fall into two categories; static and dynamic. Dynamic preferences are set at runtime through the user's event scripting and can vary based on the state of the computer, the time of day and the user or users to which they are connected. Static preferences are persisted and retrieved, but the value does not change based on the context of its use.

Scripts and other preferences are stored in a centralized data storage and the preferences are stored at various levels to allow for consistency and reuse in the system. Global preferences are the same for everyone in that conferencing system and account preferences are the same for everyone in that account. User preferences are unique to that individual, however, when users retrieve their preferences upon login, they are given the most accurate preferences that apply to them, regardless of whether it was established at the global, account or individual level. An individual reference takes precedence over an account. Preference for that individual and an account preference takes precedence over a global preference for that individual. Preferably, individuals cannot alter preferences that are not user preferences.

Preferences can be updated from the conferencing system itself and are sent back to centralized storage frequently while logged in. Preferably, only updates to preferences permitted by the account administrator are accepted.

As mentioned above, preferences, including scripts, can be viewed and updated through a centralized administration module. This allows for preferences at any level to be viewed and modified by those with appropriate permissions. Preference changes can also be applied to all users in an account without revoking an individual's permissions to change those user preferences.

The discussion of the following features that are available in the present system is mere exemplary, and it should be understood that the present invention is not limited to use of these features.

A first feature that may be implemented during a live conferencing session is an audiovisual interaction feature that allows people to simultaneously see and hear each other over the internet from their respective portals. When this feature is activated, the director preferably creates three channels in the data transport system: a control channel, an audio channel, and a video channel. During the initial negotiations, each portal transmits a list of its available video codecs to the other portal over the control channel before the conference begins. Each portal then selects a video codec to use for encoding from the available codecs sent by the other portal. Both portals also transmit quality preferences over the control channel upon startup. Both portals store these remote settings and utilize them when performance tuning the audio and video transmission, as described below. As the quality preferences change during the conference, the updated preferences are transmitted to the other portal over the control channel.

When using this audiovisual feature, the speech of the users at the portals is compressed and transmitted over the audio channel. Particularly, transmitted audio is captured by a microphone at the portal and is preferably processed through a noise cancellation module that modifies the audio data to exclude interference or other background noise, an echo cancellation module that detects and cancels any echo in the audio signal, and a silence detection module that identifies periods of silence in the transmitted audio. The silence detection module does not transmit these periods of silence. Rather, the module transmits a silence description packet to the receiver that tells it to output background noise when missing audio packets are encountered. The audio is then compressed, preferably using speech audio codec, at a bitrate indicated by the local cache of the remote portal's quality preference for audio versus video. This local value may be modified while attempting to tune the audio signal, but the current audio/video preference indicates the goal audio bitrate to be achieved when bandwidth allows. The audio data is then sent to recipient portal via a channel dedicated to audio data in the managed data transport system. This audio channel is compressed, encrypted, and sequenced, and timing is enabled to allow this channel to be synchronized with the video channel, as discussed below. The TTL on this channel is appropriately set for the audio capture rate. Priority for the audio channel must be higher than that of the video channel.

At the recipient portal, the data is received through the already established audio channel. All incoming data is first analyzed for data packet loss using sequence numbers. This packet loss information is sent back to the transmitting portal on the control channel. The audio data is then processed using a decompression module that preferably also provides some cleaning and blending of the audio signal. This decompression module also utilizes the silence description packets transmitted by the silence detection module. Whenever a missing audio packet is encountered, the decompression module outputs audio data representing the most recent silence description. This fills any gaps in the audio data with the background noise encountered elsewhere in the audio data. The audio signal is then split and sent to echo cancellation module which processes any echoes in the incoming audio data for echoes.

In order to maximize transmission quality, when a conference includes multiple portals, limits may be imposed on the number of audio and video channels that are made available. For example, if the conference includes 15 portals, only three audio channels may be established. In this instance, the conference operates in a “pass the stick” environment wherein only three users can transmit audio at one time, even though every other portal in the conference can receive the audio. Thus, audio transmission permission may be passed from portal to portal as needed.

Preferably, the audiovisual feature provides two options for video display. The portals may either use a standard web camera to transmit video to the remote portal, or the portals may present a character image or photograph to the remote user. This character image is a photo-realistic three-dimensionally rendered character animation of a person, such as a sales agent, the lips of which are synchronized with the audio that is being transmitted. The character image may be assigned a wide range of facial expressions (such as a smile, frown, etc.) and voices to effectively interact with a customer, for example, at a kiosk in a retail store. Thus, this character image feature provides for rich video interaction between portals when bandwidth constraints prevent an effective live video connection.

When the character image option is enabled on a portal, the image is sent to the remote portal via a special channel that is created by the director for this purpose. Signals indicating the start or stop of the various facial expressions may also be transmitted over this special channel. The audio is sent to a player that processes the audio data and generates the appropriate mouth movements on the character image. Preferably, the image is stored in memory at the recipient portal so that specific frames can be requested from the player as the audio data is output. This ensures that the character image motion is synchronized with the audio. In a preferred embodiment, when a facial signal is received, it is passed to the player which animates the facial expression change over the following one (1) second time frame.

If the character image option is not enabled, the video input is captured from the local portal by using a standard web camera. The video is compressed using the video codec previously selected during the initial negotiations, described above. The bitrate and frame rate of the compression is continually modified based on feedback from the recipient portal. Video data is then transmitted over the video channel through the data transport system. Similar to the audio channel, this channel is compressed, encrypted, and sequenced, and timing is enabled. The TTL on this channel is preferably set to equal the time between frames. For example, if the current frame rate is five frames per second, the TTL on the video channel should be set to 0.2 seconds or 200 milliseconds. When video is received through the video channel, it is analyzed for packet loss and the transmitter is notified just as with audio packet loss. The video data is then decoded and output through speakers at the portal.

As audio and video data arrives at the receiving portal, the receiver utilizes the timing stamp assigned by the data transport system to synchronize the audio and video channels. When possible, video packets are dropped to synchronize the data.

The transmitting portal continually receives feedback from the receiving portal regarding both video and audio packet loss. This data is sent on the control channel established when the audiovisual feature is started. The transmitting portal utilizes this information and the quality preferences from the receiving portal to continually tune the audio and video quality. This provides the best audio and video possible based on their preferences regardless of the bandwidth of the internet connection. The goal of this optimization is to achieve a 0% packet loss rate for both audio and video.

The quality preference indicates the receiving portal's preference toward video speed (frame rate) versus video quality (bitrate). This setting may be a value from 0 to 10. Zero (0) indicates quality is of maximum importance and ten (10) indicates speed is of maximum importance. Frame rate and bitrate are used to implement these settings. The video codec modifies the quality of the video to fit the frame rate and bitrate settings required. These settings are implemented as eleven (11) different scales of frame rate and bitrate values. Each scale represents a setting between 0 and 10. When video needs to be improved or degraded, the frame rate and bitrate are modified using the scale corresponding to the video quality versus speed preference. If no packet loss is occurring, the audio bitrate is increased up to the current optimal bitrate and once that is reached, the video is adjusted upwards along the sliding quality versus speed scale.

When the audiovisual feature is used in a multi-party conference, a central server is utilized that accepts audio/video streams from all participants. The central server extracts and decodes audio signals from all users, then mixes them to a multiple stream for each participant who hears audio from every one except itself. The audio mixer then encodes the mixed audio signals and sends them back to each participant. The central server also extracts and decodes video signals from all users, then mixes them to a single image that is viewed by all users. The video mixer then encodes this image at different quality levels, and sends it to each remote user according to its particular CPU and network conditions. The audio-video synchronization is maintained on a per-user basis, at both server and client sides.

In view of the forgoing, the audiovisual feature of the conferencing system balances usage and quality by enabling the portals to exchange messages and determine if setting requirements must be changed to increase or decrease resource usage. The use of the character image option and adaptive techniques to balance quality and bandwidth constraints distinguish this feature from prior art video conferencing technology.

A remote control feature of the conferencing system enables portal conference participants to display, share, and/or control applications or an entire desktop from a remote portal location. This feature is useful when a remote sales agent wishes to walk a customer at a kiosk through a brochure, help a customer complete an online form, or present multimedia presentation, for example.

The portal that is running the shared application or desktop is referred to as the host portal. Any participant can initiate the sharing of an application or desktop. However, this feature is preferably configured so that the host portal must first approve the display, share, or control of the application through its client or local settings. When an application is displayed, the images of the application at the host portal are transmitted to the remote portal for viewing. When the host portal agrees to share or grant control of the application or desktop to the remote portal, input from the remote portal's keyboard, mouse, screen, etc. is transmitted and applied to the host application. The remote portal continues to see only those images of the application that are transmitted from the host portal. The host portal is able to regain control and the remote portal is able to relinquish control of the application at any time.

Similar to the audiovisual interaction feature, when multiple portals are participating in the conference, the system may be configured so that control of the application can be transferred to only one portal at a time. In this instance, even though the other portals are not able to control the application, the system may be configured so they can highlight or draw on the screen for all of the other portals to see. In a preferred embodiment, the cursor for the drawing or highlighting may include some unique portal identifier such as a name, particular color, or number so that the other participating portals know which portal is making the marks on the screen. Any such markings are made on a transport layer over the desktop so that the controlling portal can delete all the highlights or markings.

The remote control feature adapts to network congestion and local computer bottlenecks (such as high CPU utilization) so that even with severe resource constraints, the feature still provides the best possible performance. To reduce bandwidth requirements, multiple compression techniques are used to compress the keyframes of the video feed. The smallest compression result is then transmitted to the remote computer, preferably using guaranteed data transmission. The size of this transmitted image is cached for later use. When transmission of a keyframe is complete, a new image of the application is captured and is compared to the previously stored keyframe to detect the changes (delta) in the images. If the size of the compressed delta image is smaller than last keyframe, only the delta image is transmitted to the remote portal. This process continues until the delta image is the same size as or is larger than the size of the previous keyframe image. At this time, the new keyframe image is compressed and the smallest result is transmitted to the remote portal. This process further reduces bandwidth requirements.

When the remote control feature is used in a multi-party conference, a remote control server allows the sharer to share an application with multiple clients. The remote control server keeps track of all of the clients entering and leaving a conference. The leader of the conference may designate any other client to be the sharer, however, it is preferred that there be only one sharer. When a portal joins a conference where sharing is ongoing, that portal automatically sees the shared application. The multiparty remote control server works by receiving image, mouse, and keyboard data from the sharer and distributing that data out to each portal. The server also receives data from the portals, aggregates it, and sends it to the sharer.

A media streamer feature allows portal conference participants to share various media files including, but not limited to, video files, images, sound files, etc. For example, when used in combination with the live audiovisual conferencing feature, a remote sales agent can present the user at a kiosk with marketing files and simultaneously discuss them. The media streamer feature also allows a portal to connect to streaming servers and receive streamed media from a live or on-demand source, such as pay-per-view and movies on demand.

When the media streamer feature is initialized, local media files on the host portal are streamed to the remote portal over the managed transport system. Similar to the other features in the conferencing system, the media streamer feature adapts to bandwidth and CPU usage so the streamed file continues to stream even when resources are constrained. Particularly, as a file is streamed using the media streamer feature, the audio and video bit rate may be increased or decreased and the frame rate and size may be altered. Also, the portals monitor their location in the file and synchronize the file location so the same portion of the file is seen or heard by both portals at approximately the same time. In order to achieve this synchronization, output data may either be slowed by introducing small waits or hurried by dropping video frames prior to their transmission.

The media streaming feature permits streaming in both directions between portals. Particularly, the two portals store their own files to be streamed and the role of a portal may switch between streamer and receiver between different media file streaming sessions depending on where the media files are stored. For the streaming session of that media file, the portal that has the media file in its storage will become the streamer and the other portal becomes the receiver. The media streamer feature also allows media play to be controlled by both the sending and receiving sides while the media is being streamed.

The media streamer feature is also flexible to operate in four main configurations based on the type of the media file and mode of the local play. A media file can be either in one of the general/publicly-available formats or in the proprietary streaming format. If a media file is in general/publicly-available format, the media is decompressed and recompressed before it is streamed to the other portal. Whereas if the media file is in the proprietary streaming format, media bits are simply picked from the file without performing any decompression and recompression of the media. When the local play is selected, the media is played locally on the streaming side and the streamer media is simultaneously played on the receiving side. On the other hand, when the local play is not selected, then the media is only streamed and played on the receiving portal, but not displayed locally. Thus, when the media file is in the proprietary streaming format and local play is not selected, the operation of the media streamer features is similar to the server-based video on demand streaming.

The media streamer feature is also unique in that it is capable of streaming any media file available on the user's machine on the fly without any requirement for converting the media file into a specific streaming format. The media streamer feature further adapts itself dynamically to the network bandwidth and processor usages at the two portals. Six modes are preferably defined for the media streamer feature based on the frame size the frame rate of the media file. The highest mode corresponds to the original frame size and frame rate of the media. The scaled down versions of frame size and frame rate make up other modes. The lowest mode corresponds to a frame rate of 1 frame/sec and frame dimensions equal to half of the original frame dimensions. The modes are stepped up and stepped down dynamically during streaming based on time average values of maximum CPU usages on both streaming and receiving portals. The compression bitrate is controlled by the network bandwidth and the buffer levels at the sending and the receiving portals.

When multiple portals participate in a multi-party conference, the media stream may be broadcasted to all of the participating portals. Specifically, the portal which owns the media streams it to all other portals in the conference and plays the media locally. On the multi-party conference, a control token is provided and the portal which wants to control the media play either grabs the token if it is free or asks for permission to own from the portal which already owns it. Once the token is obtained, the portal is free to control the media play. The portal which owns the media to compress pushes the highest quality compressed media to the server and the server shapes the media data based on the capacities of other portals on multi-party conference.

A text and data transfer feature provides the ability to transport text and binary data between portals, such as when using a text chat feature. Text chat uses the text and data transfer feature to allow the portals to engage in a textual conversation. This feature is particularly useful where one or all of the portals in the conference lack the capability for live audiovisual video conferencing or when one portal, such as a sales agent, wishes to handle multiple connections simultaneously or broadcast the text to multiple portals. This feature can also be used to inform the remote portal of local events happening on the host portal, such as notification that the user at the remote portal is typing. Binary data representing emoticons, such as “smile” may also be transmitted using this feature. When integrated with the character image option of the audiovisual feature described above, the binary data emoticons can be translated into facial expressions on the character image. The text chat feature can also be configured to echo messages back to the sender, in which mode the order in which all of the messages will be received by the individual systems in a multi-party conference will be guaranteed to be the same.

A graphical user interface is provided to add functionality to the text chat feature, which may include a history window, text entry area, emoticon selection, and audio/visual notification of new message arrival. Preferably, the graphical user interface encodes the text in HTML for a more pleasant display on the remote portal.

A file transfer component allows conferenced portals to quickly and securely transfer multiple types of files. For example, a remote sales agent may provide a kiosk user with order forms or information about a product. This feature is intended for the transfer of complete physical files, unlike the media streamer feature which does not ensure that the complete file is received by the remote portal. With the file transfer feature, multiple files can be exchanged at the same time and a single participant may receive and send files simultaneously. A participating portal may also block files it does not wish to receive. All files are preferably encrypted using 256 bit encryption. Like other features, this feature adapts to the CPU storage on both portals.

An input/output device feature enables a remote portal to detect peripheral devices connected to the ports of a local portal. The remote portal is able to securely send data to and receive data from devices over the internet. Similar to the audiovisual feature described above, when multiple portals are participating in the conference, token “sticks” may be passed from one portal to another so that not all portals have remote access to the I/O devices at the same time.

A legacy gateway feature enables portals on the network to send or receive conference calls that do not originate from other compatible portals on the network. For example, a calls may be converted on either the calling or receiving end into a PSTN, SIP, or H.323 format.

A text messaging feature enables users of the system to leave text messages for other users when they are unavailable, similar to text messaging on cell phones. A post office feature is also available that enables users of the system to leave audio or video messages for other users when they are unavailable. These messages are stored on a separate server until they are downloaded.

Finally, call monitoring and call recording features are also available in the present system.

To access the functionality of the conferencing system described above, a user may preferably use three different interfaces: 1) a skin-able program using standard windowing techniques; 2) the conference may be embedded in another program such as a document, email or webpage; or 3) the user may write a short automation script automating the conference initiation and component launch. The skin-able program is a full featured application which places the images and locations of buttons, labels, window shapes and all other appearance related data in a “theme-file.” This theme-file can be modified to re-brand the application, or to completely change the layout of the application. The embedability of the invention is achieved using a thin compatibility layer that can be embedded as an ActiveX or .NET control, Java component, Netscape plugin or any other existing or future technology.

When any portal in a conference is ready to end the conference call, the user may simply activate the client to end the call by pressing a button, for example, that is labeled “Hang Up” or “End Call.” Upon receipt of such action, the director terminates the data transport of the managed transport system and informs the queue server of the change in the receiving portal's status. The recipient portal is then free to take other call requests and the user of a kiosk, for example, may walk away and continue shopping.

Updates to the conferencing system of the present invention may be made available on public servers. These servers may have special software on them which allows for the synchronization of files by the transmission of the differences between the files. By using this update management system, even dialup users will be able to quickly update to the latest version of the software.

Certain modifications and improvements will occur to those skilled in the art upon a reading of the forgoing description. By way of example, the present invention is not limited to a conference between a kiosk and a remote sales agent. Rather, the conferencing system of the present invention may be utilized by any type of portal that facilitates communication. All such modifications and improvements of the present invention have been deleted herein for the sake of conciseness and readability but are properly within the scope of the present invention.

1. A conferencing system comprising:
a plurality of remote portals on a network that are adapted to generate and receive conferencing requests;
a queue server that handles conferencing requests from the plurality of remote portals;
a director that locates a router on the network to process each conferencing request; and
a plurality of features that may be accessed during a conference between at least two of the remote portals;
wherein the director establishes a peer-to-peer connection between at least two of the remote portals to create a conference.

2. The system of claim 1 wherein the remote portals are selected from the group consisting of stationary kiosks, portable kiosks, desktop computers, laptops, handheld computers, set-top boxes, cellular phones, and personal digital assistants.

3. The system of claim 1 wherein when a portal registers its presence data with the queue server, the queue server broadcasts the presence data to other portals on the network that subscribe to the registering portal's presence data.

4. The system of claim 3 wherein the presence data comprises data selected from the group consisting of login status and availability status.

5. The system of claim 1 wherein the router selects a particular portal to accept a conferencing request from another portal based on a call routing pattern.

6. The system of claim 1 wherein a plurality of peer-to-peer conferencing calls are merged into a single conferencing call for multi-party conferencing.

7. The system of claim 1 wherein each feature of the plurality of features is encased in it own process such that when one feature is terminated, the other features may continue to transmit and receive conference data.

8. The system of claim 1 wherein the director manages which features of the plurality of features are available to each remote portal on the network and user preferences.

9. The system of claim 1 wherein an audiovisual feature is provided that permits users at portals participating in a conference to simultaneously see and hear each other from their respective portals.

10. The system of claim 9 wherein a control channel, an audio channel and a video channel are established when the audiovisual feature is launched in a conference.

11. The system of claim 10 wherein the control channel transmits data from the receiving portal in a conference to the transmitting portal regarding video and audio data loss so that the transmitting portal can adjust transmission of the video and audio data to maximize user quality.

12. The system of claim 9 wherein during a multi-party conference, a central server mixes audio streams from each portal participating in the conference and sends the mixed audio stream to each participating portal.

13. The system of claim 9 wherein during a multi-party conference, a central server mixed video signals from each portal participating in the conference and sends the mixed video signal to each participating portal.

14. The system of claim 1 wherein a remote control feature enables the portals participating in a conference to share, display, and/or control software applications or an entire desktop from a remote location.

15. The system of claim 14 wherein a host portal in a conference transmits images to other portals participating in the conference.

16. The system of claim 15 wherein the host portal is configured to share or grant control of the application or desktop to the other portals participating in the conference.

17. The system of claim 1 wherein a media streamer feature enables a host portal in a conference to stream local media files to other portals participating in the conference.

18. The system of claim 17 wherein the media streamer feature dynamically adapts itself to the bandwidth and processor usages at the portals participating in the conference.

19. The system of claim 1 wherein a text data transfer feature enables real time transfer of text and binary data between portals participating in a conference.

20. The system of claim 1 wherein a file transfer feature enables portals participating in a conference to physically transfer files between them.

21. The system of claim 1 wherein an input/out feature enables a portal participating in a conference to detect and send data to peripheral devices connected to the ports of another portals participating in the conference.

22. The system of claim 1 further comprising a user interface that is skin-able user program that stores the look and feel of an application in a theme file.

23. The system of claim 1 further comprising a user interface that can be embedded into format selected from the group consisting of ActiveX, .NET control, Java, Netscape plugin, and Windows.

24. The system of claim 1 wherein a legacy gateway feature enables portals on the network to send or receive conference calls that do not originate from other compatible portals on the network by converting the calls into a format compatible with the system.

25. The system of claim 1 wherein a messaging feature enables a portal on the network to leave a message for an unavailable portal, wherein the message is selected from the group consisting of text, video, and audio messages.
